(19) United States
(12) Patent Application Publication
(10) Pub. No.: US 2012/0004794 A1
(43) Pub. Date: Jan. 5, 2012

(54) Device and Method for Task Management for Piloting an Aircraft

(75) Inventors: Fabien GUILLEY, Merenvielle (FR); Nicolas VALOT, Plaisance du Touch (FR); Gilles Jacques Yves FRANCOIS, Toulouse (FR)

(73) Assignee: THALES, Neuilly-sur-Seine (FR)

(21) Appl. No.: 12/978,136

(22) Filed: Dec. 23, 2010

(30) Foreign Application Priority Data
Dec. 30, 2009 (FR) FR 0906401

(51) Int. Cl. G05D 1/00

(52) U.S. Cl. 701/14

(57) ABSTRACT

A device and method for managing tasks for the piloting of an aircraft includes a means for detecting alerts of the flight systems and an alerts management means for presenting the alerts and the tasks of the resolution procedures to the crew. The device includes means for recording additional procedures and tasks and modifications of attributes of tasks with respect to the tasks recorded in the first recording means, a means for triggering the additional tasks able to order the alerts management means to present the additional tasks, the triggering means operating according to a mode of asynchronous acquisition of trigger data originating from the flight systems and a means for selecting the recorded additional procedures and additional tasks so as to transmit the modified procedures and the modified attributes of the tasks to the alerts management means.

### CROSS-REFERENCE TO RELATED APPLICATION

This application claims priority to foreign French patent application No. FR 0906401, filed on Dec. 30, 2009, the disclosure of which is incorporated by reference in its entirety.

### FIELD OF THE INVENTION

The present invention relates to flight management systems on board aircraft. The invention relates notably to a system for managing alerts and procedures, and more precisely to a device for managing tasks for the piloting of an aircraft.

### BACKGROUND

An aircraft crew, which includes a captain and a copilot, work in an information laden environment. In order to manage various systems of the aircraft, and to ensure basic piloting of the aircraft, the crew must perform various actions in a concurrent manner, including:
actions on primary controls of the aircraft: stick, rudder bar, engine power control, propeller pitch control, compensator control;
regular flight safety checks, by checking notably: primary flight parameters such as the engine operating parameters, the speed, the altitude; by checking the area surrounding an environment of the aircraft such as proximity to other aircraft, the terrain; faults and notably procedures to be carried out in the event of a fault;
navigation tasks relating notably to precise and complex information to be entered by the crew such as a flight plan of the aircraft;
monitoring of the ATC comprising passive listening for orders from an air traffic controller, active dialogues with a controller;
communications with an airline by way of AGARS messages, the acronym standing for the expression Aircraft Communications Addressing and Reporting System;
information about the passengers and CFPs.

In addition to these operational tasks for dealing with the flight, the crew may have to perform, subsequent to a system failure or to a flight situation of risk (meteorological impairment, terrain collision alert for example), tasks for restoring the aircraft to a normal situation. A centralized system for managing alerts, named the FWS for Flight Warning System, can apprise the crew of a set of alerts originating from various flight management and monitoring systems linked to the FWS. The alerts presented to the crew may relate to aircraft system faults. Some aircraft system faults may be mechanical faults. An example of a system subject to mechanical faults is the flight control system. Other faults may have an impact on the proper operation of the aircraft's systems such as faults affecting a hydraulic system, an electrical network, an electronic system, a computer. The various alerts may require a restoring action, relate to a warning concerning a problem with the performance of a function of the aircraft, relate to a warning indicating that the aircraft is unfit to take off again.

The FWS furthermore makes it possible to communicate to the crew a resolution procedure to be applied in the event that an alert arises, if one exists. A resolution procedure is static and determined previously in the FWS. The detection of the alerts is based on the processing of the input streams (collection of the data of the avionics systems) via logic of Boolean type: AND, OR, NOR, NOT, delay, confirmation, step, etc. This information provided to the FWS system may be simple data and alerts generated directly by the external systems. When the avionics systems host their own function for detecting functional anomalies, the alert associated with the anomaly is thereafter transmitted directly to the FWS system. The alerts are taken into account by an alerts management module and the FWS system can display the alerts and the associated procedures to the crew, so as to solve the problem related to the alert. When the information is simple data, the alerts management module interprets the data received so as to determine whether it is necessary to generate an alert. To this end, the alerts management module implements an alerts detection function. A resolution procedure can comprise several elementary steps or actions to be accomplished so as to solve the problem that generated the alert. The various associated alerts and procedures are presented to the crew by a system named the centralized monitor of the aircraft electronics, or ECAM, the acronym standing for the expression Electronic Centralized Aircraft Monitor. The ECAM makes it possible to display in a centralized manner information originating furthermore from various of the aircraft's electronic management and supervision systems.

Management of the operational tasks becomes problematic when the pilot has to carry out alert resolution tasks and operational tasks for flight planning. Indeed, the management of the operational tasks for the progress of the flight is carried out independently of that of the alert resolution tasks presented by the FWS. For example, during the progress of a flight, the crew may have to modify the route initially envisaged to avoid a meteorological zone judged a risk. For this purpose, it is necessary to carry out actions forming part of procedures particular to the situation at the navigation management system (FMS for “Flight Management System”). Moreover, it is common for these actions to have to be carried out at a precise moment of the flight plan that could occur a few hours subsequent to the crew's becoming aware. These operational flight tasks are not static and depend on each flight situation. Currently, the planning of these piloting tasks is managed manually by pilots by means of note taking on a paper pad.

Another problem area stems from the upgrading of the systems and procedures to be applied. The architecture of the FWS does not permit them to be taken into account. Indeed, certain flight procedures are defined by the companies and these procedures will be upgraded during the life of the craft. However, the FWS core is static and does not permit these upgrades to be taken into account. Consequently, the pilot must log this procedure by these own means independently of the FWS on a paper pad.

It then becomes complicated for pilots to coordinate the various operational flight tasks and the tasks for resolving an alert since this situation requires them to juggle skillfully between their note taking and the information presented by the FWS.

### SUMMARY OF THE INVENTION

The invention displays the set of tasks to be carried out on the various systems for the execution of the flight on the alerts management system and to facilitate the updating of the existing resolution procedures in the alerts management system.

More precisely, the invention relates to a device for managing tasks for the piloting of an aircraft comprising a means for detecting alerts of the flight systems and an alerts management means for presenting the alerts and the tasks of the resolution procedures to the crew, the means for detecting the alerts operating according to a mode of synchronous acquisition of status data originating from the flight systems and according to an alert detection deterministic logic so that the alerts management means displays the tasks as a function of the resolution procedures and of presentation attributes recorded in a first recording means.

Advantageously, it also comprises means for recording additional procedures and tasks and modifications of attributes of tasks with respect to the tasks recorded in the first recording means, a means for triggering the additional tasks able to order the alerts management means to present the additional tasks, the triggering means operating according to a mode of asynchronous acquisition of trigger data originating from the flight systems, a means for selecting the recorded additional procedures and additional tasks so as to transmit the modified procedures and the modified attributes of the tasks to the alerts management means.

Advantageously, it comprises a means for monitoring the status of the communication with the flight systems.

Advantageously, the means for recording the additional procedures and tasks comprise a means for modifying the procedures and attributes of tasks during the flight of the aircraft.

Advantageously, the means for recording the additional procedures and tasks comprise a means for modifying tables of configurations of the flight systems and resolution procedures.

Advantageously, the means for recording the additional procedures and tasks comprise a second means for recording the configuration upgrades of the flight systems and resolution procedures.

Advantageously, the means for recording the additional procedures and tasks comprise a third means for recording the modifications of the procedures and attributes of the tasks.

The invention relates to an alerts management system of an aircraft, comprising a device according to any one previous embodiment.

The invention also relates to a method for inserting a task for a tasks management device for the piloting of an aircraft. Advantageously, it successively comprises the following steps:

A first step of recording a file of the attributes of a task, a second step of triggering the task according to a mode of asynchronous acquisition of trigger data, a third step of selecting the last version of the attributes of the triggered task, a fourth step of displaying the task triggered according to the selected attributes.

Advantageously, during the first step, a plurality of tasks of an alert resolution procedure are recorded.

The invention presents the advantage of improving the management and the detection of alerts. Indeed, the device makes it possible to modify the procedures for resolving alerts as a function of the current context and the upgrades of the flight systems. Thus it is possible to take account of modifications of procedures related to the upgrades of the flight systems and to the requirements of the companies with greater reactivity. Moreover, the number of alerts and procedures that can be presented to the crew is not limited to the design configuration of the alerts management device.

Another advantage is the possibility of managing in a centralized manner the tasks to be accomplished during the flight since the device allows the addition and the deletion of tasks originating from any system in communication with the alerts management device. Thus, the crew is furnished with a piloting tasks display which is suited to the current situation and consequently with a more effective decision aid.

### BRIEF DESCRIPTION OF THE DRAWINGS

The invention will be better understood and other advantages will become apparent on reading the nonlimiting description which follows and by virtue of the appended figures among which:

FIG. 1 represents a simplified diagram of the functions implemented by the tasks management device.

FIG. 2 represents a simplified diagram of the steps of the method for inserting tasks for the tasks management device.

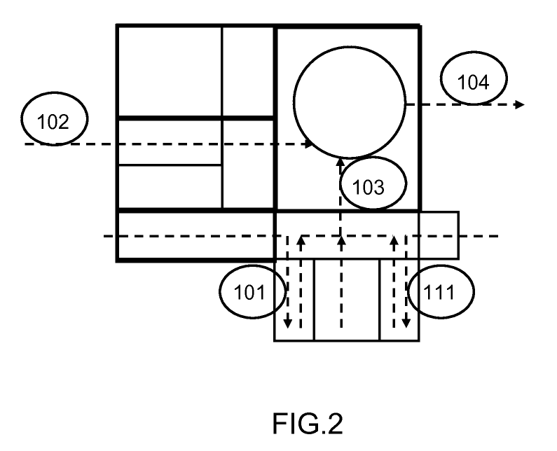

### DETAILED DESCRIPTION

The present invention relates to a tasks management device for the piloting of an aircraft, in particular for aircraft comprising numerous flight systems with which the crew must interact so as to carry out the piloting tasks. These flight systems are for example a navigation management system, the meteorological monitoring system, the anticollision monitoring system and the system for communication between the aircraft and the outside. The tasks management device must also allow the carrying out of the tasks for resolving alerts by presenting the resolution procedures comprising several resolution tasks to be executed successively. Preferably, the functions of the device according to the invention are implemented by an alerts management device of an aircraft.

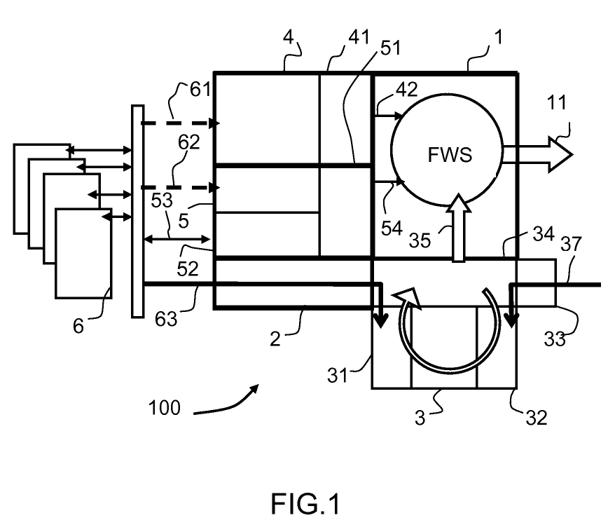

FIG. 1 represents a simplified functional diagram of an alerts management device 100 of an aircraft. The alerts management device 100 is in communication with the aircraft's various flight systems 6 (flight controls, navigation management system, meteorological system, etc.). The alerts management device receives as input status data 61 for the flight systems 6. These data 61 may be data of alerts or simple data. On the basis of these data, a means for detecting alerts 4, operating according to a mode of synchronous acquisition of the status data 61, activates an alert at an interface 41 in communication with the alerts management means 1 (the FWS core). This interface comprises one or more active alerts 42 which are transmitted to the alerts management means 1 so as to be presented to the crew with a resolution procedure if the latter exists.

During the design of the alerts management device, several resolution procedures are recorded in a historical database 3. These resolution procedures are dependent on the avionics architecture of the aircraft, the flight systems 6 and the airlines defining their own resolution procedures. When an alert 42 is activated in the interface 41, the alerts management means 1 identifies the alert and associates the resolution procedure related to this alert so as to present on a man-machine interface not represented in the diagram the alert, the dedicated resolution procedure and the tasks to be carried out to accomplish this resolution procedure. Audio and visual alerts may be associated with the detected alerts. The audio alerts are selected from a database of audio messages provided for this purpose. The visual alerts are displayed on the screens provided for this purpose in the cockpit and the flight cabin. The Arinc 661 and TFTP (“Trivial File Transfer Protocol”) protocols make it possible to communicate with the CDS (“Cockpit display system”).

The database 3 containing the piloting procedures and tasks is static. The information contained therein is formulated for an initial configuration of the FWS and depends intimately on the means for detecting alerts whose logic facilities are also static and determined for an initial configuration of flight systems.

The alerts management device comprises supplementary means 2, 31, 32 and 33 for adding tasks, procedures and alerts to the configuration of the device 100. These means comprise an interface with the protocol management flight systems 6 making it possible to create a procedure configuration file (“template”) or tasks file in a database 31. This interface receives as input configuration instructions 63 created by a member of the crew. Thus, it is possible for the crew to overload or add or instantiate procedures without modifying the initial application of the alarms management device. These data are contained in a second database 31 additional to the first database 3 containing the initial configuration. Operationally, on the initiative of a crew member, an alert, a procedure or a task and their presentation attributes may be modified before the flight during the flight preparation phase or during the progress of the flight. The crew member can formulate the configuration file on his input console and subsequently record these modifications in this second database 31. This protocol management interface 2 is used for the temporary procedure modifications in response to a specific requirement in a particular flight context.

A third database 32 is used to record permanent procedure updates 37 corresponding to upgrades of flight systems 6 for example or changes of procedures with respect to the initial procedures requested by the aircraft's operating companies. Operationally, these permanent configuration files, commonly “plugins”, are downloaded in the course of a maintenance action on the aircraft or of important updates of flight systems. A configuration table 33 records the historical log of these modifications.

The tasks management device 100 comprises an interface 5 for managing tasks with the flight systems 6 for adding or deleting an alert, a procedure or a task having to be presented to the crew. This interface 5 receives trigger data 62 of the flight systems 6 according to a mode of asynchronous acquisition. When requested by the flight systems 6, the interface 5 activates alerts, procedures or tasks 54 in an interface 51 communicating with the alerts management means 1.

The alerts, procedures (comprising several tasks) and tasks 54 which are presented by the interface 51 arising from the tasks management interface are elements additional to the alerts 42 that may be presented by the interface 41 for activating alerts arising from the detection logic facilities 4. The procedures and tasks associated with the tasks 54 are recorded in the second or third database 31 and 32.

An interface 34 between the alerts management means 1 and the first, second and third databases 3, 31 and 32 makes it possible to dispatch to the alerts management means 1 the last modifications of the procedures and tasks 35 on triggering of a task presented on the interface 51 or presented on the interface 41. The interface 34 carries out the function for abstracting the data dispatched to the alerts management means with respect to those contained in the first and third databases 3 and 32.

The tasks management device also comprises a means 52 for monitoring the status of the communications between the device 100 itself and the flight systems 6. This monitoring means 52 makes it possible to raise if necessary an alert in the event of loss of communication with the system in question. To this end, a periodic message 53 is transmitted so as to be certain of the life of the flight system connected to the tasks management device.

The invention also relates to the method for inserting tasks into a tasks management device. This method comprises a first step 101 or 111 of modifying the attributes of a task or of a procedure with respect to their initial definition such as contained in the first database 3. These modifications are recorded in the third database 32 during a static update 111 of the procedures and tasks by data downloading 37. Or, in a context of temporary modification for a flight or during the flight for the requirement of a specific flight situation, the procedure modifications and attributes of a task are recorded in the second database 31 by modification request 101 initiated by a member of the crew. The method thereafter comprises a second step 102 of triggering the task, the effect of which is to activate a task in the interface 51. The alerts management means 1 thereafter associates in a third step 103 the new procedure and the new task presentation attributes 35 with the activated task 54. In a fourth step 104, the alerts management means presents the task activated according to the attributes recorded in the databases 31 or 32.

1. A device for managing tasks for the piloting of an aircraft comprising a means for detecting alerts of the flight systems and an alerts management means for presenting the alerts and the tasks of the resolution procedures to the crew, the means for detecting the alerts operating according to a mode of synchronous acquisition of status data originating from the flight systems and according to an alert detection deterministic logic so that the alerts management means displays the tasks as a function of the resolution procedures and of presentation attributes recorded in a first recording means, the device comprising:
means for recording additional procedures and tasks and modifications of attributes of tasks with respect to the tasks recorded in the first recording means,
means for triggering the additional tasks able to order the alerts management means to present the additional tasks, the triggering means operating according to a mode of asynchronous acquisition of trigger data originating from the flight systems, and
means for selecting the recorded additional procedures and additional tasks so as to transmit the modified procedures and the modified attributes of the tasks to the alerts management means.

2. A device according to claim 1, further comprising a means for monitoring the status of the communication with the flight systems.

3. A device according to claim 1, wherein the means for recording the additional procedures and tasks comprise a means for modifying the procedures and attributes of tasks during the flight of the aircraft.

4. A device according to claim 1, wherein the means for recording the additional procedures and tasks comprise a means for modifying tables of configurations of the flight systems and resolution procedures.

5. A device according to claim 1, wherein the means for recording the additional procedures and tasks comprise a second means for recording the configuration upgrades of the flight systems and resolution procedures.

6. A device according to claim 1, wherein the means for recording the additional procedures and tasks comprise a third means for recording the modifications of the procedures and attributes of the tasks.

7. An alerts management system of an aircraft, comprising a device for managing tasks for piloting according to claim 1.
